(19) United States
(12) Patent Application Publication
(10) Pub. No.: US 2019/0016982 A1
(43) Pub. Date: Jan. 17, 2019

(54) MESITYLENE AS AN OCTANE ENHANCER FOR AUTOMOTIVE GASOLINE, ADDITIVE FOR JET FUEL, AND METHOD OF ENHANCING MOTOR FUEL OCTANE AND LOWERING JET FUEL CARBON EMISSIONS

(71) Applicant: Swift Fuels, LLC, West Lafayette, IN (US)

(72) Inventors: Donald L. Bower, West Lafayette, IN (US); Philip J. Catania, West Lafayette, IN (US); Edward Johnson, West Lafayette, IN (US); Kenneth Kasper, West Lafayette, IN (US); John J. Rusek, West Point, IN (US); Jonathon D. Ziulkowski, West Lafayette, IN (US); Chris D'Acosta, West Lafayette, IN (US); Thomas Albuzat, Homburg (DE); Brian Stirm, Delphi, IN (US)

(73) Assignee: Swift Fuels, LLC, West Lafayette, IN (US)

(21) Appl. No.: 16/134,073

(22) Filed: Sep. 18, 2018

Related U.S. Application Data
(63) Continuation of application No. 15/492,470, filed on Apr. 20, 2017, now abandoned.
Application No. 15/492,470 is a continuation of application No. 15/051,728, filed on Feb. 24, 2016, now abandoned.
Application No. 15/051,728 is a continuation-in-part of application No. 14/314,645, filed on Jun. 25, 2014, now abandoned.
Application No. 14/314,645 is a continuation of application No. 12/885,693, filed on Sep. 20, 2010, now abandoned.
(60) Provisional application No. 61/243,699, filed on Sep. 18, 2009.

(51) Int. Cl. C10L 10/10; C10L 1/02; C10L 1/06; C10L 1/04

(52) U.S. Cl. CPC C10L 10/10; C10L 2270/023; C10L 1/231; C10L 1/06; C10G 2300/301; Y02P 30/20; C10L 1/04; Y02T 50/678; Y02E 50/13; C10L 2230/22; C10L 2200/0469; C10L 2200/043; C10L 2200/0423; C10L 2200/024; C10L 1/026

(57) ABSTRACT

A motor fuel comprising gasoline comprising 70-99 wt % gasoline and 1 to 30 wt % of mesitylene. This fuel can advantageously contain conventional additives used in gasoline. The use of mesitylene in gasoline blend yields a fuel blend with a higher research octane number and motor octane number. In addition, an improved jet fuel is provided, having from 1-10 wt % mesitylene added to the jet fuel, having improved carbon emission characteristics while maintaining required specifications. Further, an improved bio-fuel is provided, which may function as a replacement for conventional Jet A/JP-8 fuel and has lowered carbon emission specifications, the bio-fuel comprised of 75-90 wt % synthetic parafinnic kerosene (SPK) and 10-25 wt % mesitylene.

### REFERENCE TO RELATED APPLICATIONS

The present application is a Continuation of U.S. application Ser. No. 15/492,470, filed Apr. 20, 2017, which is a Continuation of U.S. application Ser. No. 15/051,728, filed Feb. 24, 2016, which is a Continuation of U.S. application Ser. No. 14/561,748, filed Dec. 5, 2014, which is a Continuation-In-Part of U.S. application Ser. No. 14/314,645, filed Jun. 25, 2014, which is a Continuation of U.S. application Ser. No. 12/885,693, filed Sep. 20, 2010, which claims the benefit of U.S. Provisional Patent Application 61/243,699, filed Sep. 18, 2009, the contents of which are hereby incorporated by reference.

### BACKGROUND OF THE INVENTION

### Field of the Invention

The present invention relates in general to fuels and fuel additives and, more particularly, to motor gasoline and jet fuel, and additives for enhancing the octane number of motor gasoline and lowering carbon emissions of jet fuel. In one aspect, the present invention is concerned with a fuel additive for motor fuel for enhancing the research octane number, and in another aspect to a fuel additive for enhancing the motor octane number. Another aspect of the present invention is concerned with providing a replacement additive for alcohol in motor fuels. In addition, an improved jet fuel is provided, having biomass-based and/or petroleum-based mesitylene therein, which acts to lower carbon emissions. Further, a method is provided for enhancing the octane of motor fuels by adding such mesitylene to petroleum-based gasoline, as well as additional fuel additives.

### Description of Related Art

U.S. Pat. No. 4,398,921 discloses using a fuel additive of ethanol in automotive gasoline to boost the octane number. Ethanol was also thought to stretch the remaining worldwide supply of crude oil. There are at least two major problems with using ethanol as a fuel additive. The first problem is that ethanol-infused automotive gasoline results in much reduced mileage per gallon when compared with 100% pure gasoline. A second problem is that ethanol, at least domestically, is produced almost entirely from corn which negatively impacts on our food supply.

A careful analysis of most petroleum distillates used in the production of gasoline reveals that many trace hydrocarbons can be found. Included in those trace hydrocarbons is occasionally mesitylene, but only in very minor trace amounts of less than 0.1 wt %.

It is therefore an object of the present invention to provide a fuel additive which will boost the octane rating of automotive grade gasoline.

Another object of the present invention is to provide a fuel additive which can be combined with gasoline to boost the octane number and improve the mileage values for modem automobiles.

Yet another object of the present invention is to provide a fuel additive which can replace ethanol currently used in gasoline, and which will provide a fuel blend with improved mileage which will not negatively impact on our food supplies.

Still another object of the present invention is to provide a fuel additive which can be used to replace ethanol in gasoline, and which will provide a greater mileage range than alcohol containing gasoline.

Another object of the invention is to provide a motor fuel, having a Final Boiling Point (“FBP”) less than or equal to 225° C. and preferably 170° C. to 225° C., a MON of 80 to 94 and preferably at least 91, and an RVP at 38° C. of 38-103 kPa and alternatively 38-49 kPa.

### BRIEF SUMMARY OF THE INVENTION

The present inventors have conducted research in earnest to find a fuel additive which will provide all of the benefits of ethanol without being derived from foodstuffs such as corn. The present inventors unexpectedly discovered that a fuel additive comprising mesitylene (1,3,5-trimethylbenzene) can be employed in automotive gasoline in an amount of from about 1 to 30 wt % to boost both the research octane number and the motor octane number of these fuels. It was also unexpectedly discovered that mesitylene, both bio-derived and petroleum-derived, could be used as a satisfactory replacement for ethanol in gasoline, and that the resultant gasoline/mesitylene blend would satisfy the quality fuel standard of ASTM D4814.

In a preferred embodiment, mesitylene fuel additive in an amount of about 5 to 15 wt % can be used in automotive grade gasolines (fuels) as a replacement for ethanol. These resulting blends of gasoline have surprisingly been found to produce higher research octane numbers and motor octane numbers than pure gasoline obtained from petroleum.

In another preferred embodiment, mesitylene is blended with automotive grade gasoline that does not contain ethanol. It was found that mesitylene has a higher motor octane number than ethanol and a higher energy density. This translates directly into increased mileage over ethanol-gasoline blends. This added energy of mesitylene also eliminates the need for using corn, and other foodstuffs such as sugar cane, in producing high-energy fuels.

In a first preferred embodiment, there is provided an improved motor fuel providing higher mileage per gallon (than conventional or ethanol-containing gasoline) comprising gasoline produced from petroleum and at least 1 wt % of mesitylene.

In a second preferred embodiment, there is provided in the motor fuel of the first preferred embodiment a gasoline which is a hybrid compound incorporating additives selected from the group consisting of combustion catalysts, burn rate modifiers, stabilizers, demulsifiers, dispersants, corrosion inhibitors, catalysts, detergents, ethers, antioxidants, anti-knock agents, lead scavengers, fuel dyes, and mixtures thereof.

In a third preferred embodiment, there is provided in the motor fuel of the first preferred embodiment a gasoline containing additives to increase fuel economy selected from the group consisting of Ferox, Oxyhydrogen, ferrous picrate, and mixtures thereof.

In a fourth preferred embodiment, there is provided an improved motor fuel yielding higher mileage per gallon, said motor fuel comprising:
(a) gasoline produced from petroleum; and
(b) from between about 1 to 30 wt % of mesitylene, based on the total weight of the motor fuel.

In a fifth preferred embodiment, there is provided in the motor fuel of the fourth preferred embodiment a gasoline which is a hybrid compound incorporating additives selected from the group consisting of combustion catalysts, burn rate modifiers, stabilizers, demulsifiers, dispersants, corrosion inhibitors, catalysts, detergents, ethers, antioxidants, anti-knock agents, lead scavengers, fuel dyes, and mixtures thereof.

In a sixth preferred embodiment, there is provided in the motor fuel of the fourth preferred embodiment a gasoline which contains additives to increase fuel economy selected from the group consisting of Ferox, Oxyhydrogen, ferrous picrate, and mixtures thereof.

In a seventh preferred embodiment, there is provided an improved motor fuel yielding higher mileage per gallon and comprising gasoline produced from petroleum and from about 5 to 15 wt % of mesitylene.

In an eighth preferred embodiment, there is provided in the motor fuel of the seventh preferred embodiment a gasoline which is a hybrid compound incorporating additives selected from the group consisting of combustion catalysts, burn rate modifiers, stabilizers, demulsifiers, dispersants, corrosion inhibitors, catalysts, detergents, ethers, antioxidants, anti-knock agents, lead scavengers, fuel dyes, and mixtures thereof.

In a ninth preferred embodiment, there is provided in the motor fuel of the seventh preferred embodiment a gasoline, which is a hybrid compound, incorporating additives to increase fuel economy selected from the group consisting of Ferox, Oxyhydrogen, ferrous picrate, and mixtures thereof.

In a tenth preferred embodiment, there is provided in the motor fuel of the first preferred embodiment a gasoline component having a research octane number of at least 91.6 and a motor octane number of at least 83.4.

In an eleventh preferred embodiment, there is provided in the motor fuel of the fourth preferred embodiment a gasoline component having a research octane number of at least 91.6 and a motor octane number of at least 83.4.

In a twelfth preferred embodiment, there is provided in the motor fuel of the seventh preferred embodiment a gasoline component having a research octane number of at least 91.6 and a motor octane number of at least 83.4.

In a thirteenth preferred embodiment, there is provided in the motor fuel of the first preferred embodiment a gasoline which is obtained from petroleum having a research octane number of about 91.6.

In a fourteenth preferred embodiment, there is provided in the motor fuel of the seventh preferred embodiment a gasoline obtained from petroleum which has a research octane number of about 91.6, and in admixture with mesitylene has a research octane number of at least 94.6.

In a fifteenth preferred embodiment, there is provided in the motor fuel of the seventh preferred embodiment a gasoline obtained from petroleum having a research octane number of about 88.4, and in admixture with mesitylene a research octane number of at least 90.9.

In a sixteenth preferred embodiment of the present invention, a method of increasing the research octane numbers and motor octane numbers of pure gasoline obtained from petroleum comprising mixing with said gasoline mesitylene in an amount sufficient to create a blended motor fuel comprising from about 1 to about 30 wt % of mesitylene.

In a seventeenth preferred embodiment, the method of the sixteenth preferred embodiment above is provided, further comprising adding one or more additives selected from the group consisting of combustion catalysts, burn rate modifiers, stabilizers, demulsifiers, dispersants, corrosion inhibitors, catalysts, detergents, ethers, antioxidants, anti-knock agents, lead scavengers, fuel dyes, and mixtures thereof to the blended motor fuel.

In an eighteenth preferred embodiment, the method of the sixteenth preferred embodiment above is provided, further comprising adding one or more additives to increase fuel economy selected from the group consisting of ferrocene compounds and derivatives thereof (such as Ferox®), oxyhydrogen, ferrous picrate, and mixtures thereof.

In a nineteenth preferred embodiment, an improved jet fuel (turbine fuel) having lowered carbon emission specifications is provided, comprising 90-99 wt % petroleum-derived jet fuel, and 1-10 wt % of biomass-derived or petroleum-derived mesitylene. In a most preferred embodiment, the improved jet fuel is comprised of 97 wt % jet fuel and 3 wt % mesitylene.

In a twentieth preferred embodiment, an improved an improved bio-diesel and/or bio-turbine fuel having lowered carbon emission specifications is provided, comprising 75-90 wt % synthetic parafinnic kerosene (SPK), and 10-25 wt % of biomass-derived mesitylene. In a more preferred embodiment, the improved bio-diesel fuel is comprised of 85 wt % SPK and 15 wt % biomass-derived mesitylene. In a most preferred embodiment, the improved bio-turbine fuel is comprised of 80 wt % SPK and 20 wt % biomass-derived mesitylene.

In a further preferred embodiment, the invention comprises a motor fuel comprising a mixture of gasoline and mesitylene and having a Final Boiling Point (“FBP”) max of 225° C., a MON of 80 to 94 and preferably at least 91, and an RVP at 38° C. of 38-103 kPa and alternatively 38-49 kPa.

### DETAILED DESCRIPTION OF THE INVENTION

In the present invention, mesitylene in an amount of at least 1 wt % can advantageously be added to any grade of gasoline. In a preferred embodiment, the mesitylene is added to a commercial grade of gasoline having a research octane number of at least about 88 and a motor octane number of at least about 81. In a more preferred embodiment, a high grade gasoline is used having a research octane number of at least about 91 and a motor octane number of at least about 83.

In a further present invention, biomass-derived mesitylene in an amount of from 10-26 wt % can advantageously be combined with SPK (synthetic paraffinic kerosene) to provide an improved diesel or turbine fuel.

The mesitylene used in the present invention can be obtained commercially by various known chemical processes, or it can be obtained by fermentation and further chemical processing of natural products such as corn, sorghum, sugar cane, sugar beets and even cellulosic materials such as certain grasses, brush, and wood. It was unexpectedly found that mesitylene, when blended with commercial grades of gasoline, meets the major parameters of the ASTM D4814 specification for automotive gasoline. These tests demonstrate that the improved motor fuel of the present invention qualifies for use in automobiles used in the United States.

According to the present invention, the gasoline component can be a hybrid compound blending in combustion catalysts such as organo-metallic compounds, burn rate modifiers to increase the fuel time burned, stabilizers/demulsifiers/dispersants to prolong the life of the fuel and prevent contamination, corrosion inhibitors, catalyst additives to prolong engine life and increase fuel economy, and detergents to clean the engines.

In a preferred embodiment, the fuel of the present invention can contain oxygenates including alcohols and ethers. In addition, the improved fuel of the present invention can include antioxidants, stabilizers, and antiknock agents, lead scavengers for leaded gasoline as well as the common fuel dyes. Other fuel additives which can be used include ferrocene compounds and derivatives thereof (such as Ferox®), catalyst additives that increase fuel economy, oxyhydrogen used to inject hydrogen and oxygen into the engine, and ferrous picrate to improve combustion and increase fuel economy.

The improved fuel of the present invention is not harmful to the environment and does not release any harmful gas and particulate matter emissions from a motor vehicle and its engines.

### Example 1

A number of gasoline/mesitylene blends were prepared and tested as described hereinafter. The results of these tests are shown in Table 1, which describes tests of four fuels, and the research octane number (RON) and motor octane number (MON) for each fuel.

TABLE 1

| Wt % of N-87 (87 octane) gasoline | 100 | 95 | 90 | 85 |
|---|---|---|---|---|
| Wt % of mesitylene | 0 | 5 | 10 | 15 |
| Research octane number | 91.6 | 93.3 | 94.6 | 96.1 |
| (BRE/30.2 in/129 F.) | | | | |
| Motor octane number | 83.4 | 84.3 | 84.5 | 84.8 |
| (BRE/30.2 in/300 F.) | | | | |

### Example 2

A number of gasoline/mesitylene blends were prepared and tested as described hereinafter. The results of these tests are shown in Table 2 which describes tests of four fuels, and the research octane number (RON) and motor octane number (MON) for each fuel.

TABLE 2

| Wt % of regular gasoline (ethanol free) | 100 | 95 | 90 | 85 |
|---|---|---|---|---|
| Wt % of mesitylene | 0 | 5 | 10 | 15 |
| Research octane number (RON) | 88.4 | 89.5 | 90.9 | 93.2 |
| (BRE/30.2 in/129 F.) | | | | |
| Motor octane number (MON) | 81.4 | 81.6 | 82.2 | 83.1 |
| (BRE/30.2 in/300 F.) | | | | |

It can be seen from the test results shown in Tables 1 and 2 above that the addition of various components of mesitylene to several grades of gasoline produced markedly improved research and motor octane numbers (RON and MON). Unlike general aviation, RON is just as important as MON in automotive fuel. Importantly, it has been found that the average of the MON and RON, listed at the pump as (R+M)/2, increased to 87+, which is equivalent to regular unleaded gasoline. This is significant because it is the overall same increase achieved using ethanol without the significant mileage deduction. Stated another way, the biomass-derived mesitylene-containing gasoline of the present invention is a substitute for ethanol-containing conventional gasoline, in that petroleum content of the fuel is decreased as required by law in many U.S. states, which provides increased mileage in comparison to the ethanol-containing conventional gasolines now sold.

In another aspect of the invention, a motor fuel according to the invention comprises a mixture of gasoline and mesitylene and the resulting fuel has a Final Boiling Point (“FBP”) max of 225° C., a MON of 80 to 94 and preferably at least 91, and an RVP at 38° C. of 38-103 kPa and alternatively 38-49 kPa. The fuel preferably does not include a significant amount of lead, and more preferably does not include any lead. In a further aspect, the fuel has a 90% boiling point (“BP”) max of 190° C. or 185° C., and optionally a 90% BP of 130° C. to 185° C. or 190° C. The motor fuel of this embodiment is useful as an automotive fuel, but also is useful as an aviation gasoline (“avgas”).

For this embodiment, the mesitylene may be present in an amount of at least 1 wt % of the fuel, and in some embodiments is preferably present in an amount of 1 wt % to 30 wt %. In other embodiments, the amount of mesitylene may be 5, 10 or 15 wt %, or within a range spanning any of 1, 5, 10, 15, 20 and 30 wt %. Thus, for example, the mesitylene may comprise 1-5 wt % or 10-20 wt %, etc.

It is a further feature of this embodiment of the invention that the fuel is characterized by the fact that it has a FBP max of 225° C. and alternately an FBP of 170° C. to 225° C., and in all other respects meets all major requirements, and preferably all other requirements, of ASTM D7547. The fuel is thus well suited for use in aviation engines that can operate with a fuel having this high level of FBP. Since the mid-1990's, there have been a substantial number of spark-ignited piston engine aircraft (approximately 35% of the fleet) allowed by FAA supplemental type certifications to utilize autogas as a direct alternative to avgas providing safe fuel for flight. Those select aircraft certified to use commercially certified autogas and avgas interchangeably have no particular engine configuration or modification that makes autogas adaptable other than having lower compression ratios and a less stringent need for high motor octane number (MON) fuels. Such aircraft engines typically operate below 7.5:1 compression ratios and require low vapor-pressure gasoline-based fuels typically ranging from 80 MON up to 94 MON. This invention uses small quantities of mesityene whose final boiling point exceeds 170° C. but is below 225° C. for use in general aviation piston engine aircraft.

Similarly, it is a feature of this embodiment of the invention that the fuel is characterized by the fact that it has an RVP at 38° C. of 38-103 kPa. As set forth in ASTM D4814, an RVP of 54-103 kPa is approved for use in automotive engines, and thus a fuel of the invention having an RVP in this range is suitable for such use. Alternatively, ASTM D7547 indicates an acceptable RVP range of 38-49 kPa, and thus a fuel of the invention having an RVP in this range is suitable as avgas. In addition, it is known that aviation engines are also operated outside of the range of requirements in ASTM D7547, and thus the inventive fuels having an RVP outside of the certified range also provides a fuel suitable as avgas in those instances.

Gasoline is a complex mixture of hydrocarbons and each boils at different temperatures. For an internal combustion engine to operate properly, some components of the fuel must vaporize at low temperatures to ensure ease of starting and throttle response. Mid- to high-boiling fuel components include hydrocarbons that have a higher density and higher octane to produce power in the combustion process.

Liquid fuel does not burn as it does not mix well with oxygen. Therefore all of the fuel components must vaporize to mix with oxygen from the atmosphere to burn completely in the engine. Internal combustion gasoline engines typically use a lighter fraction of the refined crude oil components, ones that have a lower carbon number (C₄ to C₁₂, which typically boil up to about 225° C.). These are vaporous components that mix with oxygen in atmospheric engines.

The fuel distillation curve is often depicted in percentages of evaporated material and is adjusted by selecting hydrocarbon components that vaporize at different temperatures to achieve the desired performance.

| % Fuel | Distillation Curve, ASTM D86 | | | | | |
|---|---|---|---|---|---|---|
| Evaporated | D910 avgas | | D7547 avgas | | D4814 autogas | |
| Initial boiling | Report | | Report | | Report | |
| point | | | | | | |
| 10% volume | max | 75° C. | max | 75° C. | max | 70° C. |
| 40% volume | min | 75° C. | min | 75° C. | min | 75° C. |
| 50% volume | | | | | min | 77° C. |
| 50% volume | max | 105° C. | max | 105° C. | max | 121° C. |
| 90% volume | max | 135° C. | max | 135° C. | max | 190° C. |
| Final boiling | max | 170° C. | max | 170° C. | max | 225° C. |
| point | | | | | | |
| Sum 10% + | min | 135° C. | min | 135° C. | min | 135° C. |
| 50% BP | | | | | | |
| DI (1.5ₜₑₙ + | | | | | max | 597° C. |
| 3_{fifty} + 1_{ninety}) | | | | | | |

In the low percentage or front-end of the distillation curve, the volatility of the fuel is impacted by the mix of critical gasoline components with balanced vapor pressures (VP) to provide easy starting in both cold (higher VP) and hot (lower VP) conditions, freedom from vapor lock and other hot fuel handling problems, and low evaporation and fuel loss emissions. In the mid-range of the distillation curve, the fuel composition is adjusted to achieve effective engine warm-up with smooth operation, effective power and fuel economy, and effective protection against carburetor icing and stalling. In the high end of the distillation curve, especially as the fuel approaches the final boiling point, the fuel composition is adjusted to achieve effective fuel economy, minimal engine deposits and dilution of engine oil with fuel, and reduction of exhaust emissions especially of volatile organic compounds (VOC's)

As discussed above, in addition to motor fuel, the present inventors have found that an improved jet fuel, having lowered carbon emission specifications while maintaining other important characteristics within required specifications, can be obtained by adding thereto biomass-derived mesitylene in a certain weight range. In particular, such an improved jet fuel is comprised of 90-99 wt % petroleum-derived jet fuel, and 1-10 wt % of mesitylene.

In a most preferred embodiment, the improved jet fuel is comprised of 97 wt % jet fuel and 3 wt % mesitylene. This particular improved jet fuel composition was experimentally verified by testing performed by an independent testing laboratory. In particular, a jet fuel composition comprised of 97 wt % conventional jet fuel, and 3 wt % mesitylene was prepared, and the characteristics thereof determined to be as shown in Table 3 below:

TABLE 3

| ASTM | | | |
|---|---|---|---|
| Method | Parameter | Value | |
| D 3242 | Acid number | 0.002 | mg KOH/g |
| D 1319 | Aromatics | 16.3 | volume % |
| D 3227 | Mercaptan sulfur | 0.0005 | mass % |
| D 5453 | Sulfur | 556 | mg/kg |
| D 56 | Flash point | 57° | C. |
| D 4052 | Density 15° C. | 817.9 | kg/m3 |
| D 2386 | Freezing point | −46.5° | C. |
| D 445 | Viscosity, −20° C. | 5.534 | mm²/s |
| D 4809 | Net heat of combustion | 42.990 | MJ/kg |
| D 1018 | Hydrogen | 13.59 | mass % |
| D 1322 | Smoke point | 20.5 | mm |
| D 1840 | Naphthalenes | 1.56 | volume % |
| D 130 | Corrosion copper strip (2 h/100° C.) | 1a | |
| D 3241 | Thermal Oxidation Stability | | |
| | (2.5 h/260° C.) | | |
| | Heater tube deposit rating, visual | 1 | |
| | Filter pressure drop | 4.6 | mm Hg |
| D 381 | Existent gum | 2 mg/100 mL | |
| D 3948 | Water separation, MSEP-A rating | 83 | |
| D 86 | Distillation | | |
| | 10% Recovered | 185.5° | C. |
| | 50% Recovered | 216.0° | C. |
| | 90% Recovered | 252.0° | C. |
| | Final boiling point | 274.0° | C. |
| | Residue | 1.0 | volume % |
| | Loss | 0.5 | volume % |
| | (Barometric pressure, 761.0 mm Hg; | | |
| | Procedure arithmetical | | |

In a further preferred embodiment, as mentioned above, an improved bio-fuel, which can function as both bio-diesel and bio-turbine fuel, has been developed by the present inventors, which has been found to favorably have lowered carbon emission specifications. This improved bio-fuel is currently intended for use in turbine engines, as well as possibly diesel engines, as ethanol (which is currently contained in most gasoline) is not allowed in turbine fuel. Such improved bio-turbine/diesel fuel is comprised of 75-90 wt % synthetic parafinnic kerosene (SPK), and 10-25 wt % of biomass-derived mesitylene. In a more preferred embodiment, the improved bio-diesel fuel is comprised of 85 wt % SPK and 15 wt % biomass-derived mesitylene. In a most preferred embodiment, the improved bio-turbine fuel is comprised of 80 wt % SPK and 20 wt % biomass-derived mesitylene.

In order to determine the characteristics of such bio-fuel, as compared to conventional fuels, four test compositions (fuel blends) were prepared, as outlined in Table 4 shown below. Of the four test compositions prepared, test composition #4, having 20 wt % mesitylene, exhibited characteristics closest to conventional Jet A/JP-8 fuel. In particular, every tested parameter for test composition #4 meets the standards for Jet A/JP-8 fuel. By interpolation, a composition having 84 wt % bio-SPK and as low as 16 wt % MES will meet the specifications for Jet A/JP-8 fuel as well. In contrast, as illustrated in Table 4 below, test composition #1, comprised solely of bio-SPK, does not meet the density specification for Jet A and JP-8, which is 0.775-0.840 kg/L.

It was unexpectedly discovered that adding mesitylene at 16 wt % or greater insures that important parts of ASTM D 1655 and MIL-DTL-83133E, which are the specifications for Jet A and JP-8 respectively, are met. Further, such bio-fuel should not contain greater than 25 wt % mesitylene, as the standards for Jet A and JP-8 list the maximum aromatic content at 25 wt %. The test composition containing 20 wt % of mesitylene is most preferred, as this content of mesitylene eliminates the issues that bio-SPK has with seals (i.e., seals won't swell to the necessary degree without some level of aromatics (mesitylene in this case) in the fuel) while meeting all parameters for Jet A and JP-8. It has been found that adding mesitylene to the mixture in a 20 wt % content provides both the necessary seal swelling characteristics, while also being less damaging on those same seals versus other lighter aromatics such as toluene and xylene. Accordingly, the inclusion of mesitylene in the claimed ranges decreases issues with over-swelling and deterioration of seals in the engine.

TABLE 4

| Test Composition #: | 1 | 2 | 3 | 4 |
|---|---|---|---|---|
| % Tri-Methylbenzene | 0 | 5 | 10 | 20 |
| (Mesitylene): | | | | |
| % HRJ Tallow (bio-derived SPK): | 100 | 95 | 90 | 80 |
| ASTM D 4052 - 09 Density | 0.758 | 0.763 | 0.769 | 0.779 |
| @ 15° C. (kg/L) | | | | |
| ASTM D 445 - 09 Viscosity | 5.3 | 4.6 | 4.2 | 3.5 |
| @ −20° C. (mm²/s) | | | | |
| ASTM D 445 - 09 Viscosity | 10.6 | 9.8 | 8.9 | 7.2 |
| @ −40° C. (mm²/s) | | | | |
| ASTM D 445 - 09 Viscosity | 1.4 | 1.3 | 1.3 | 1.1 |
| @ 40° C. (mm²/s) | | | | |
| ASTM D93 - 09 Flash Point, ° C. | 55 | | | 52 |
| ASTM D5972 - 09 Freezing Point, | −62 | | | <−77 |
| ° C. | | | | |

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed:

1. A motor fuel comprising 70-99 wt % gasoline and 1-30 wt % mesitylene.

2. The motor fuel of claim 1 comprising 80-99 wt % gasoline and 1-20 wt % mesitylene.

3. The motor fuel of claim 1 comprising 80-95 wt % gasoline and 5-20 wt % mesitylene.

4. The motor fuel of claim 1 comprising 80-90 wt % gasoline and 10-20 wt % mesitylene.

5. The motor fuel of claim 1 in which the motor fuel has a FBP max of 225° C., a MON of 80 to 94, and an RVP of 38-103 kPa.

6. The motor fuel of claim 5 in which the motor fuel has a FBP of 170° C. to 225° C.

7. The motor fuel of claim 6 in which the motor fuel has a 90% BP max of 185° C.

8. The motor fuel of claim 7 in which the motor fuel has a 90% BP of 130° C. to 185° C.

9. The motor fuel of claim 5 in which the motor fuel has a MON of at least 91.

10. The motor fuel of claim 9 in which the motor fuel has a FBP of 170° C. to 225° C.

11. The motor fuel of claim 5 in which the motor fuel has an RVP of 38-49 kPa.

12. The motor fuel of claim 11 in which the motor fuel has a FBP of 170° C. to 225° C.

13. The motor fuel of claim 11 in which the motor fuel has a MON of at least 91.

14. The motor fuel of claim 13 in which the motor fuel has a FBP of 170° C. to 225° C.

15. The motor fuel of claim 14 in which the motor fuel has a 90% BP max of 185° C.

16. The motor fuel of claim 15 in which the motor fuel has a 90% BP of 130° C. to 185° C.

17. The motor fuel of claim 16 which is free of lead.

18. The motor fuel of claim 14 comprising 80-99 wt % gasoline and 1-20 wt % mesitylene.

19. The motor fuel of claim 14 comprising 80-95 wt % gasoline and 5-20 wt % mesitylene.

20. The motor fuel of claim 14 comprising 80-90 wt % gasoline and 10-20 wt % mesitylene.

21. An avgas comprising 70-99 wt % gasoline and 1-30 wt % mesitylene and having a FBP max of 225° C., a MON of 80 to 94, and an RVP of 38-103 kPa.

22. The avgas of claim 21 comprising 80-95 wt % gasoline and 5-20 wt % mesitylene.

23. The avgas of claim 21 having a FBP of 170° C. to 225° C., an RVP of 38-49 kPa, and a MON of at least 91.

24. The avgas of claim 23 comprising 80-95 wt % gasoline and 5-20 wt % mesitylene.

25. The avgas of claim 24 which is free of lead.
